(19) United States
(12) Patent Application Publication
(10) Pub. No.: US 2009/0260289 A1
(43) Pub. Date: Oct. 22, 2009

(54) Door Safety System

(76) Inventors: Michael Carpenter, Maynard, MA (US); David Whelihan, Framingham, MA (US)

Correspondence Address: Nields, Lemack & Frame, LLC, 176 E. Main Street, Suite #5, Westborough, MA, 01581, US

(21) Appl. No.: 12/105,400

(22) Filed: Apr. 18, 2008

(51) Int. Cl. E05F 15/12

(52) U.S. Cl. 49/26; 49/506

(57) ABSTRACT

A system and method for minimizing door related injuries are disclosed. Briefly, a mechanism requiring little or no external power is used to vary the force needed to open a door. If an obstruction (i.e. a person, pet, etc) is within the sweep of the opening door, the force needed by the user to push open the door will be increased, to give the user tactile feedback that an accident may be imminent. The feedback mechanism can be implemented in a variety of ways, including embodiments that require no external power or battery. A sensor is used to detect the presence of an obstruction within the sweep of the door. In a further embodiment, a mechanism is used to slow or stop a door from closing if an obstruction (such as a finger) is in the return path of the door.

### BACKGROUND OF THE INVENTION

Every year, thousands of people are hurt in door related injuries. These injuries include getting one's fingers trapped in a closing door, or being hit by a door opening unexpectedly.

In fact, a 1997 study by the Consumer Product Safety Commission (CPSC) estimated that there were over 340,000 non-glass door related injuries annually in the United States that required Emergency Room (ER) visits. This injury data was collected from over 100 hospitals across the country, using 15,000 categories of consumer products through the National Electronic Injury Surveillance System (NEISS).

The following table shows the number of non-glass door related injuries, as compared to other common injuries. This type of injury occurs as often as football related injuries and is three times more prevalent than toy related injuries.

ER Visits per Year by Injury Type

| Cause of Injury | ER Visits/Year (1000s) |
|---|---|
| Toys | 136 |
| Glass Doors & Windows | 167 |
| Football | 334 |
| Non-glass Doors | 342 |
| Basketball | 645 |
| Stairs, Ramps | 1753 |

In addition, as might be expected, the incidence rate of door injuries is not evenly distributed across all age groups. Among the entire U.S. population, there is an estimated 128 door injuries per 100,000 people. However, that incidence rate is nearly triple for toddlers aged 4 and under, who experience 370 door injuries per 100,000 toddlers.

Furthermore, this data understates the magnitude of the problem, since only Emergency Room visits were considered. Those injuries that were tended to at home, in a doctor's office or in the hospital (but not the emergency room) were not counted in the above statistic.

The above analysis clearly shows a problem with door related injuries, especially in toddlers. A system to alleviate this problem is clearly beneficial.

### SUMMARY OF THE INVENTION

The problems of the prior art are alleviated by the present invention, which includes a system and method for minimizing door related injuries. Briefly, a mechanism requiring little or no external power is used to vary the force needed to open a door. If an obstruction (i.e. a person, pet, etc) is within the sweep of the opening door, the force needed by the user to push open the door will be increased, to give the user tactile feedback that an accident may be imminent. The feedback mechanism can be implemented in a variety of ways, including embodiments that require no external power or battery. A sensor is used to detect the presence of an obstruction within the sweep of the door. In a further embodiment, a mechanism is used to slow or stop a door from closing if an obstruction (such as a finger) is in the return path of the door.

### BRIEF DESCRIPTION OF THE DRAWINGS

FIG. 1 illustrates several scenarios in which the present invention may be effective;

FIG. 2 illustrates a first embodiment of the mechanical configuration of the present invention;

FIG. 3 illustrates a first embodiment of the force feedback device;

FIG. 4 illustrates the two modes of operation for the motors of FIG. 3;

FIG. 5 illustrates a variable braking system for the force feedback device of FIG. 3;

FIG. 6 illustrates a second embodiment of the force feedback device;

FIG. 7 illustrates a third embodiment of the force feedback device;

FIG. 8 illustrates the overall system;

FIG. 9 is a representative flowchart describing the operation of the device in a first scenario;

FIG. 10 shows the detection areas used in conjunction with the flowchart of FIG. 9;

FIG. 11 is a representative flowchart describing the operation of the device in a second scenario;

FIG. 12 shows the detection areas used in conjunction with the flowchart of FIG. 11;

FIG. 13 is a representative flowchart describing the operation of the device in a third scenario;

FIG. 14 is a graph showing the voltage output of the motors in one embodiment of the force feedback device;

FIG. 15 shows two embodiments with different tactile feedback devices; and

FIG. 16 illustrates an additional embodiment of the force feedback device.

### DETAILED DESCRIPTION OF THE INVENTION

A door system comprising a force feedback device and a sensor is used to eliminate the high incidence of door related injuries. In operation, when the sensor detects an obstacle or obstruction in the door's sweep, it signals the force feedback device, which then varies the force required by the operator to open the door.

A force feedback device is defined as a device that supplies opposing force against motion initiated by the operator of the door. In other words, the force feedback device resists the efforts of the operator in opening or closing the door, as appropriate. The purpose of the force feedback device is to communicate to the door operator that there is a potential issue with the action that they are undertaking. This communication is most preferably tactile, such as by increasing the difficulty in moving the door. Alternatively, the communication may be visual or acoustic.

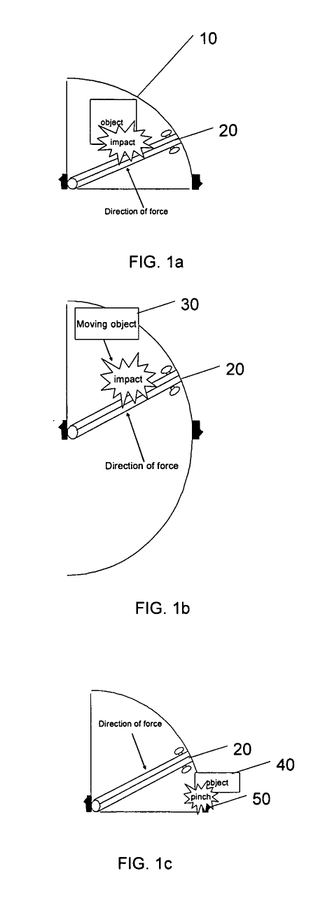

FIG. 1 illustrates three common modes where the force feedback device can be utilized. The first scenario, shown in FIG. 1a illustrates the case where a stationary object 10 is within the sweep of the door 20. In this case, continued opening of the door 20 by the operator will cause the door to impact the object 10. The second scenario, shown in FIG. 1b, illustrates the case where a moving object 30 may not be in the sweep of the door 20 as it is being opened, but enters the sweep as the door 20 continues to be opened. The third scenario, shown in FIG. 1c, illustrates the case where an object 40 enters the door's return path, where it is likely that it will be pinched between the door 20 and the door frame 50.

There are a number of criteria that are preferable for the force feedback device.

First of all, in the first two scenarios, the force feedback system preferably hinders, but does not stop, the operator's ability to move the door. For example, in the case of an emergency, the inability to open a door could be catastrophic. Thus, the device preferably does not make the operation of the door impossible or impractical in any circumstance.

Secondly, the force feedback device preferably requires little or no external power, and thus does not rely upon an electrical connection. Clearly, the use of an electrical outlet may be problematic, in view of the proximity of the door to an outlet and the potential for dangerous electrical wires lying on the floor near the door. Instead, the device preferably utilizes an internal, preferably regenerative power source. Types of power sources include batteries, solar, and kinetic energy supplier by the operator (in the form of door movement). This list is not intended to be exhaustive, only to enumerate some of the power alternatives that are available.

Third, the force feedback device is preferably relatively small, so as to be installed on or near the door or door frame. A large device, while functional, may be considered impractical in a residential setting.

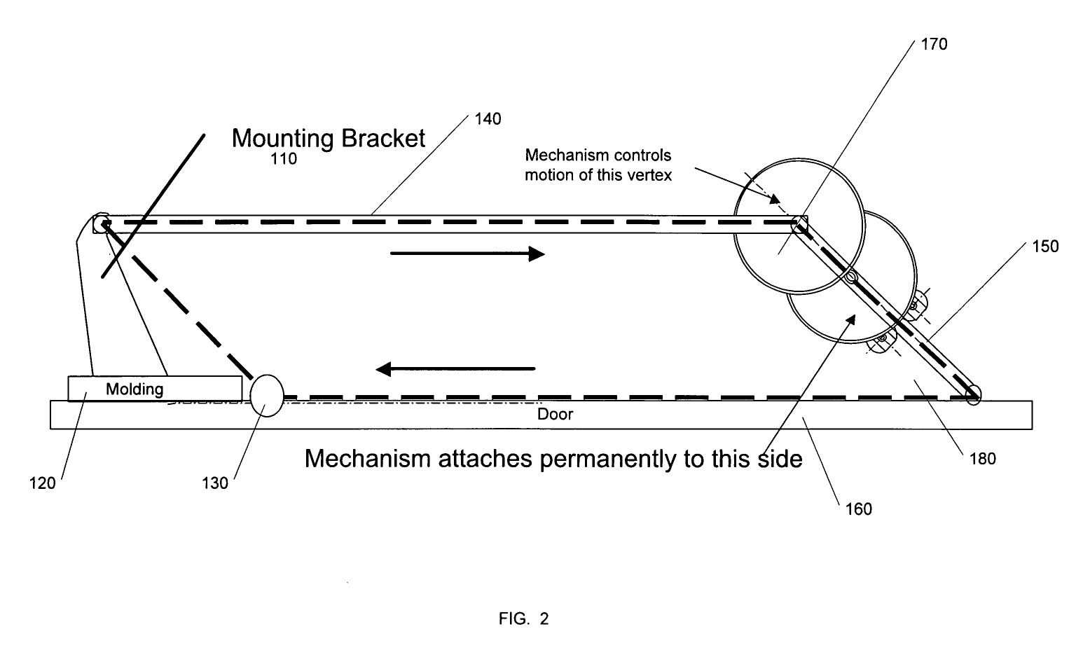

A first embodiment of a suitable force feedback device is shown in FIG. 2. In this embodiment, a bracket 110 is mounted on the door frame 120, on the side nearest the hinge 130. This bracket 110 is pivotally connected to a first arm 140. First arm 140 is pivotally connected to a second arm 150. The second arm 150 is pivotally attached to the door 160. As the door 160 is opened, the angle 170 between the two arms 140, 150 decreases, while the angle 180 between second arm 150 and the door 160 increases. By controlling the rate at which one or both of these angles 170, 180 can change, the device can provide tactile feedback to the user.

Other bracket configurations are also possible and this embodiment is not intended to represent the only implementation. For example, two arms may be pivotally attached to the door hinge, wherein one arm is in contact with, or affixed to the door and the other is in contact with, or affixed to the door frame, molding, or other suitable location. The rate at which the angle between these arms can change provides the tactile feel to the user.

Having described the mechanical configuration of the device, mechanisms to provide the force feedback will be described. One embodiment utilizes electromechanical breaking. A motor and a generator have the exact same basic design. A motor is comprised of one or more energizable windings, a magnet, and a rotating spindle. When a voltage is applied to the windings of the motor, the rotating spindle tends to move to reorient the relative polarity of the permanent and induced magnetic fields, thereby generating motion.

Similarly, if one were to forcibly turn the spindle without applying power to the windings, one would measure an alternating electric potential on the winding, as it moves through the electric field, thereby creating a generator. Those skilled in the art will recognize that an inductor will resist a changing electric field and therefore a change in current through the winding by generating a voltage as given by the equation: V₁=L di/dt, Where L is the inductance of the coil. By continually turning the shaft, a voltage is generated that is proportional to speed of the changing magnetic field caused by rotation within the stationary field. In power generation applications, this voltage (and current) can be used to do work, such as light lights, or in the case of an electric vehicle, where a single motor is used for motion and breaking, recharging batteries.

When the wires of a motor used in generation mode are unconnected, aside from friction, very little energy is expended to rotate the spindle, which can be accomplished fairly effortlessly. However, when a load is applied, such as a battery or other electronic device, more work is required to turn the spindle. The extreme is reached when the wires are shorted together, and the load is theoretically infinite. This results in more work being necessary to rotate the spindle. On a typical motor made only for drive, this effect is slight, but when the motor is geared down significantly, the breaking force can be formidable.

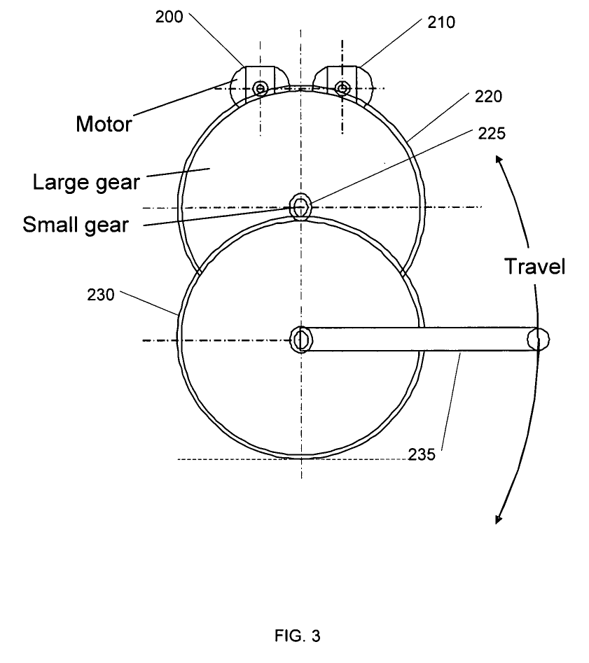

FIG. 3 shows an example of two motors 200, 210, one being used as a generator 210, that can be utilized in conjunction with the present invention. Two gears 220, 230 are used to properly control the device. The motors 200, 210 are in contact with the first gear 220, along its outer radius. Typically, toothed gears are used to couple the motors to the outer radius of gear 220. A smaller gear 225, rigidly connected to gear 220, is coupled to gear 230 along its outer radius. Gear 230 is coupled to the movement of the door, such as via angle 170, 180 in FIG. 2. In one embodiment, an arm 235 extends from gear 230. The movement of the door causes a corresponding movement of gear 230, which produces significantly more movement in gear 220. This movement in turn, causes rotation of the spindle in motor 210, which produces an electrical current. The exact gear ratios are not necessarily fixed, and should be tailored to the particular needs of the application. Factors such as the weight of the door and the geometry of the mechanical configuration might require higher or lower gearing. In the embodiment shown in FIG. 2, the travel arm is connected in such a way that it is coupled to the motion of the angle 180 of the parallelogram.

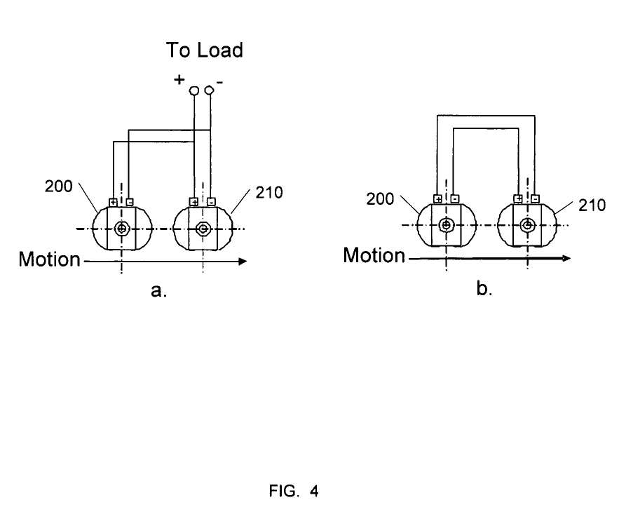

FIG. 4 shows various electrical connections for these two motors 200, 210. These motors have two modes of operation. In passive mode, illustrated in 4a, the motors generate a voltage at their terminals that can be combined to charge a limited load. The load is preferably limited because passive mode should impede the door's motion minimally. If the load is too high, the device may be partially activated, and the operator will feel resistance. Since today's circuits have modest current requirements, it should be possible to charge the overall system (including sensors for object detection) by taking a small amount of current. In FIG. 4b, the motors 200, 210 are shown in active braking mode. The motors are turning in the same direction at the same speed and therefore generate a very similar voltage across their terminals. By connecting the negative terminal on one motor to the positive terminal on the second motor, and the positive terminal on the first motor to the negative terminal on the second motor (the motors are cross-connected), the motion of each motor impedes the other motor's motion (and vice versa) by attempting to drive the motor each motor in the opposite direction from the force. Essentially, the device redirects the user's force against them. Therefore, the process of inhibiting the movement of the door requires no electrical power from the system.

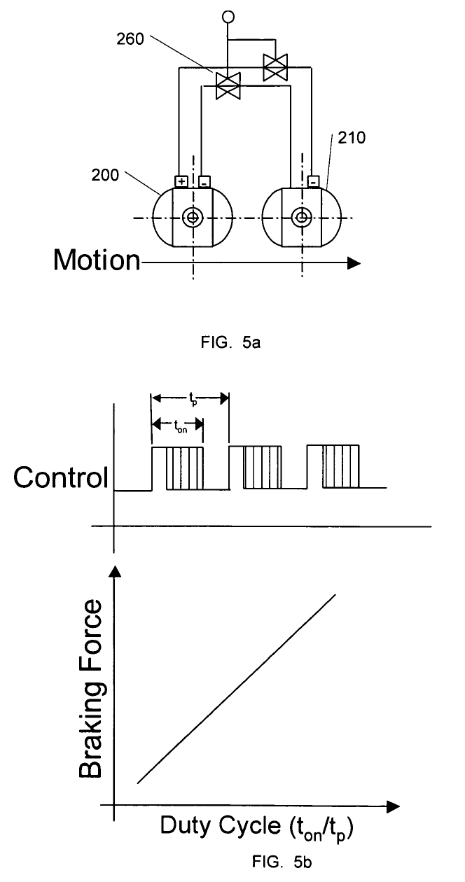

While the above description implies that braking is either enabled or disabled, the invention is not so limited. The brake configuration is not necessarily only two states (braking or not). It is within the scope of the invention to control the interface between the two motors with high accuracy, allowing for a wide spectrum of resistances. A simple pulse-width modulation (PWM) controller system (not shown) can be used to vary the aggregate time during which the two motors are opposing each other. FIG. 5a illustrates the connections between the motor poles being controlled with high accuracy by switching them with relays 260, such as solid state bi-lateral switches. By varying the percentage of time that the oscillating control line is high, the braking force can be directly affected as shown in FIG. 5b. This allows for a wide variety of braking techniques.

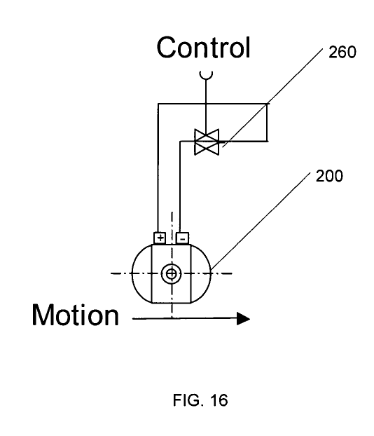

While the above description utilizes opposing electric motors to create the required tactile resistance, the invention is not so limited. For example, a single electric motor can be utilized in the present invention, as shown in FIG. 16. In this mode, the two leads of the motor 200 are connected via a relay 260 or other switching device. When there is no obstruction present, the relay 260 remains open. In this mode, the leads of the motor can be used to supply power as described above. When an obstruction is detected on the opposite side of the door, the controller closes the relay 260, thereby shorting the leads of the motor 200. This presents a very large load to the motor, making it more difficult to move the door. Furthermore, other force feedback devices are also applicable in the present invention.

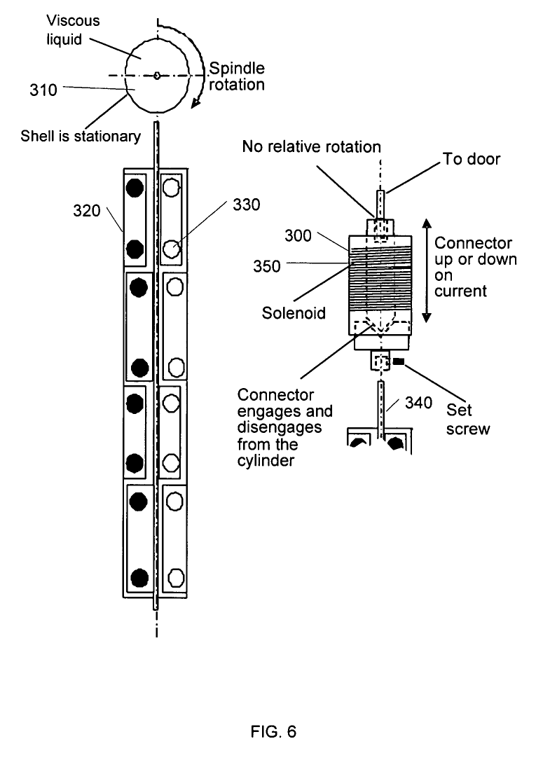

FIG. 6 shows a second embodiment of the force feedback device. In this embodiment, the resistance is provided by the movement of paddles through a viscous fluid. The force feedback device has a cylinder 300, containing a viscous fluid 310. One or more rotating paddles 320 are inserted into the cylinder 300. The paddles 320 have a center of rotation that corresponds to the center of the cylinder 300. The paddles 320 also have some mechanism by which the fluid can move around them. In FIG. 6, the paddles 320 are shown with holes 330, through which the fluid can pass. In an alternate embodiment, the paddles 320 do not extend completely to the cylinder walls, allowing the fluid to pass between the paddles and the cylinder 300. A spindle 340 rotates in response to the movement of the door. This spindle 340 can be based on the angle 170 shown in the mechanical configuration of FIG. 2. Alternatively, those skilled in the art will recognize that other methods can be used to design a spindle whose movement corresponds to that of the door.

In the preferred embodiment, the spindle 340 moves whenever the door is moved, regardless of whether an obstruction is present. Rather, the presence of an obstruction physically couples the spindle 340 and the paddles 310. In other words, the spindle 340 is not physically coupled to the paddles 310 unless an obstruction is present. Thus, the paddles are not forced to rotate unless an obstruction is present. In the preferred embodiment, a solenoid 350 is used to move the spindle and/or paddles to allow this coupling action to occur. In one embodiment, the cylinder, paddles and spindle are configured such that gravity biases the device into the normal state, where the force feedback device is inactive. This saves power, as this is expected to be the typical condition. However, one may also configure the unit such that gravity biases the device into the braking state.

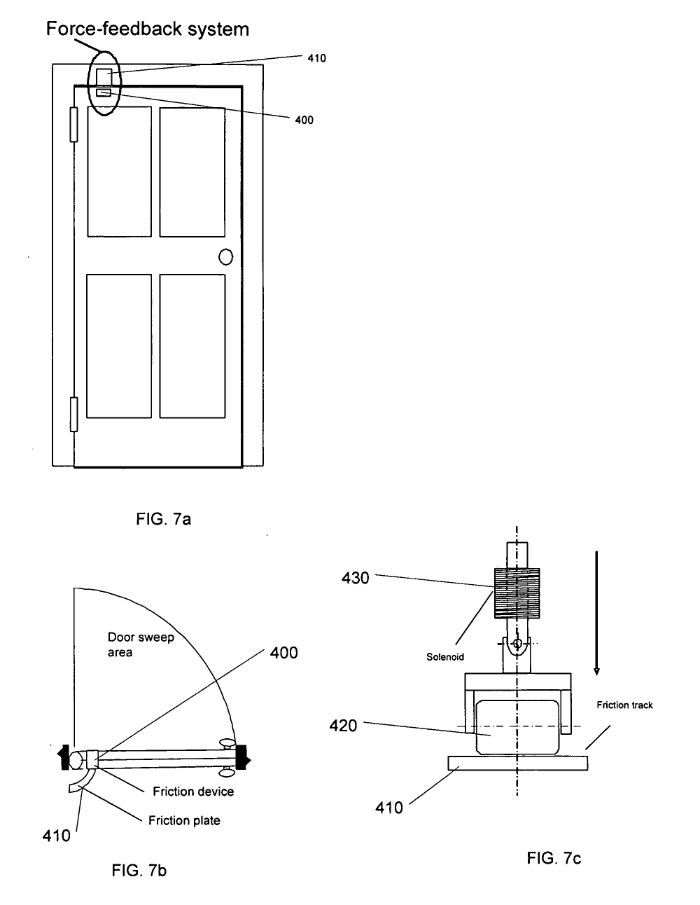

FIG. 7 illustrates another embodiment of the force feedback device. In this embodiment, a friction plate 400 is added to the top surface of the door, and designed so as to follow the sweep of the door. A friction device 410 is then affixed to the doorframe above the door, in alignment with the friction plate 400, as shown in FIG. 7b. The friction device 410 is a device which contacts the friction plate 400 when the sensor indicates an obstruction is present. In one embodiment, shown in FIG. 7c, the device is capable of rotary movement, such as a wheel 420. A solenoid 430 is used to either move the device into contact with the plate, or move the device 410 away from the plate 400. In some embodiments, the solenoid 430 is either activated, or deactivated, allowing the system to have two states, normal and braking. In other embodiments, a PWM controller as described above is used to vary the force with which the friction device presses onto the friction plate 400.

The embodiment of FIG. 7 can be varied. For example, the friction plate can be affixed to the door frame, and the friction device can be affixed to the door. Alternatively, the friction device can be installed near the bottom of the door. In this configuration, it extends to touch the floor in braking mode, and recedes in normal mode. In this mode, the friction device may rotate as shown in FIG. 7c. Alternatively, it may be a non-movable device, in which the operation must overcome the friction caused by the contact of the friction device with the floor.

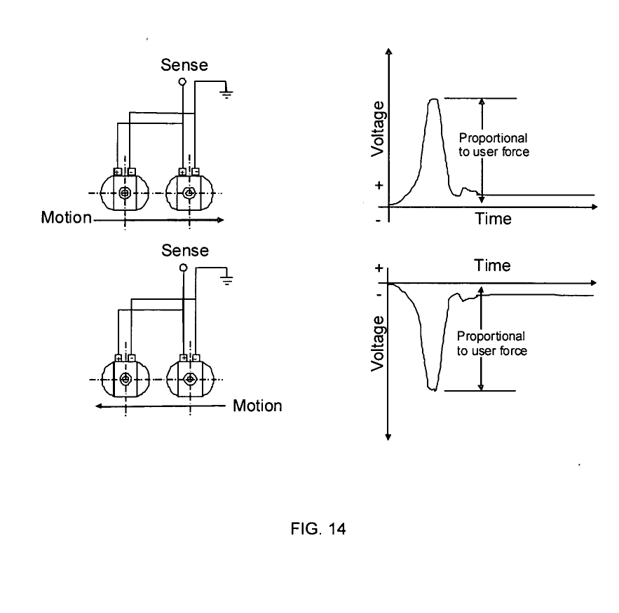

While the use of at least one motor provides the required force feedback, it also serves a second purpose. The motor can also provide an input to the system, specifically, the speed and direction of the door movement. FIG. 14 shows representative graphs showing the voltage output sensed by the motor configuration in two modes. The upper picture shows the voltage spike that would be encountered if the door's position was changed, such as when it was opened. The lower picture shows the voltage spike that would be encountered if the door's position was changed in the opposite direction, such as when the door was closed. Note that the polarity of the voltage spike represents the direction of the door movement, while the magnitude of the spike represents the force that the operator applied, or the speed of the movement. Additionally, the area under the curve (i.e. the integral) can be used to determine the absolute position of the door, if desired.

The descriptions above are not intended to represent all configurations of a force feedback device. Rather, these are representative of the types of devices that can be utilized. Those skilled in the art will recognize that other configurations can be used to create a force feedback device.

It should be noted that all of the configurations listed above are suitable for all three scenarios described in conjunction with FIG. 1. In addition, other types of devices may be used to guard against the third scenario. This scenario does not require the force feedback associated with the first two scenarios. Rather, it is sufficient to simply stop the door from closing when an obstruction is detected.

In one embodiment, a device is affixed to the hinge side jamb. When an obstruction is detected, the device extends into the space between the door and the jamb, thereby preventing the door from shutting completely. The positioning of this device can be actuated by a solenoid. Alternatively, an airbag type device can be placed in the jamb. A small amount of air would be used to inflate this device to prevent the door from slamming.

The present invention also requires a sensing element, used to detect when an obstruction is in the door's sweep. A number of different types of sensors can be utilized in the present invention.

A Passive Infrared (PIR) sensor detects body heat. These are generally used in automatic lights and security systems. They are fairly inexpensive, and can be situated such that they have a high degree of directionality(D). This means that they can be aimed to provide spot coverage of an area. In this case, they are ideal for detecting body heat in a small area in the door sweep zone. Because PIR sensors do not emit radiation of their own, they are low-power and can be used as a primary (always watching) sensor.

Active Infrared (AIR) sensors detect proximity from a few centimeters to meters by illuminating the area in front of the AIR sensor with Infra-Red light from an LED. A phototransistor detects reflected light from objects in the beam. AIR sensors are also inexpensive. While they can be more selective in the types of objects they select and also have a narrower sensor area, the fact that they emit their own light makes them consume more power than a PIR sensor. These are preferably not used as primary sensors, and would instead be turned on to get more information once a primary sensor detected an object.

A capacitive touch sensor works by detecting minute changes in capacitance caused by an object like a hand touching a metal plate. These are commonly used in homes on light switches. The size of the plate is highly variable. One downside of capacitive touch switches is that they need an earth ground for high accuracy. Though some sensors employ dynamic sampling (digital techniques) to get around this, they tend to be more expensive. Depending on the environment however, a non-grounded touch sensor may work. A capacitive touch sensor is really just a simple electrical circuit tied to a metal plate. Other similar sensors exist that detect AC current induced in our bodies from household current. These work provided that there are AC sources nearby. These touch sensors are extremely low power and therefore qualify as a primary sensor.

Ultrasonic sensors are commonly used on automobiles for proximity detection (on bumpers). They send out a high frequency sound wave that reflects off of objects in the sense area and is picked up again by a special microphone. The distance to an object can easily be determined by the round-trip-time of the sound. Since these devices send out an acoustic wave, they do not work well against soft objects. However, they work very well against solid objects. These sensors are inexpensive and their technology is not particularly exotic, owing to the fact that they have been in use for decades. Since they actively generate an acoustic wave, they are not preferable as primary sensors.

A voltage sensor is a specialized circuit for detecting the voltage across two terminals. They are very simple and employ common components, and can be made very cheaply. They also use very low power and can be sensing all the time without significantly impacting overall power consumption.

These sensors can be connected to a control unit, such as by electrical conduit. Alternatively, they may wirelessly communicate to the control unit. Having described both the force feedback devices and the various types of sensors, the implementation of the three typical scenarios will be described.

The first scenario, as shown in FIG. 1a, occurs where the door is being pushed open from one side, and unbeknownst to the operator, there is an obstruction, such as a small child on the other side of the door. If the operator pushes slowly, the child may be able to back away in time, but because the operator has no information as to the state of the door sweep space, it is more likely that he will open the door so as to pass through it as efficiently as possible, thereby risking striking the obstruction on the other side.

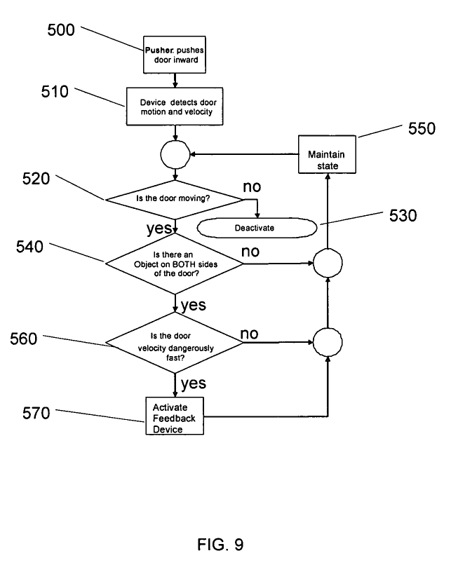

A representative flowchart for this scenario is illustrated in FIG. 9. The process is entered when the operator pushes open the door, in step 500. At that instant, the system, which is in passive mode, detects a voltage spike and notes the polarity (as explained in reference to FIG. 14), in step 510. If there is no motion, the system will return to passive mode, in box 530. If the voltage is again sampled and found to be significant (as shown in 520), the system can observe whether there is an object on both sides of the door in step 540. The fact that there needs to be an object pushing and obstructing requires that it be determined that the initial door motion was not caused by someone pulling the door toward them, since a puller would be considered an obstruction, and is therefore responsible for moving out of the door sweep area. If the door moves, and there is only one obstruction/mover (either a person pushing or pulling open the door), then there is no reason to activate the break, because the pusher/puller has complete situational awareness, and does not need help. Thus, if there is not an object on both sides of the door, the system maintains its current state and does not become active, as shown in box 550. If there are obstructions on both sides (i.e. a pusher and an obstruction), then the system will determine whether the speed of the door movement is dangerously fast, as shown in box 560. If the door is moving slowly, no action needs to be taken and the system maintains its current state in box 550. If the door is deemed to be moving too quickly, the system activates the force feedback device, thereby providing feedback to the pusher in box 570. In another embodiment, the speed of the door is not sensed, and the system is activated based solely on the presence of obstructions.

In the scenario described above, four pieces of information are needed:

1. Is the door moving?

2. How fast is the door moving?

3. Is there an obstruction in the sweep area?

4. Is there a pusher?

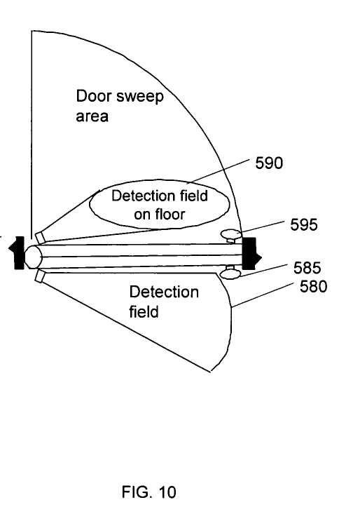

The first two pieces of information can be ascertained using simple voltage sensors in communication with the motors shown in FIG. 4. As noted above, in certain embodiments, the second piece of information is not used. The latter two can be determined using PIR sensors on either side of the door as shown in FIG. 10. The PIR detection field 580 on the Pusher side of the door should preferably extend the height of the door in space, and 20-30 cm away. In fact, this field really only needs to detect the presence of a hand on the door. Therefore, an AIR sensor that is conditionally activated based on door motion could also be used. In another embodiment, a touch sensor can be used on the door knob 585 to detect the presence of a pusher. The detection field 590 of the other PIR sensor should preferably be trained at the floor in front of the door, up to and including the knob-side jamb. This will minimize false positives from objects (children) outside of the door sweep area. If it is near the knob, it will also detect the feet of adults attempting to open the door.

It is also possible that in this scenario, the door is locked, and the Pusher requires the Puller to open the door. This case can be detected by sensing the presence of the Puller's hand on the door knob 595 using a touch sensor. In another embodiment, the system engages, but senses increased force and slowly backs the brake off until the door opens normally. In another embodiment, the system is active until the puller moves outside the detection field 590.

The second scenario, shown in FIG. 1b, serves to prevent or mitigate the effect of impacts from a door opening against a moving object. This scenario is most commonly seen at a restaurant kitchen, where the door is capable of swinging in both directions.

In this mode, the door can swing inwards or outwards. In this scenario, there are two people approaching the door from opposite sides, and one is slightly closer to the door than the other, and will therefore push the door before the other user pushes the door. Since the other pusher is moving forward, the combined speed of the second pusher and the moving door can be dangerous. The goal is to present information to the first pusher by providing feedback using the mechanism. This scenario differs from the previous scenario in that there is no “Puller”. Rather, either party can be a Pusher. Thus, the first person to the door will be referred to as the Pusher in this scenario, while the second person, still approaching the door, will be referred to as the “Late Pusher”.

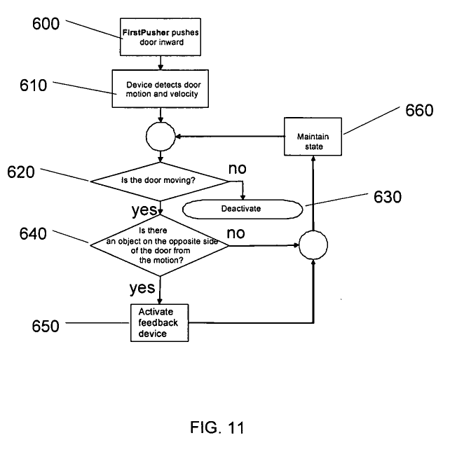

In this scenario, the door can swing both ways, and any actor can be the Pusher. This relieves the constraint in FIG. 9 where a Puller approaches the door. In this scenario, the only information necessary to decide about system activation is whether the door is being pushed and in which direction, and whether there is an obstruction on the other side of the door. This simplified flow chart is illustrated in FIG. 11.

The Pusher arrives at the door in Box 600. The system detects the door motion and velocity as described above, in box 610. While there is no door movement, the system is deactivated, as shown in box 630. The system will then determine if there is an object on the side of the door toward which the door is moving, as shown in box 640. If there is such an object, the system will engage, as shown in box 650. In all other cases, the system will maintain its state, as seen in box 660.

Another possibility in this scenario is to measure the velocity of the incoming Late Pusher and adjust the feedback force to correspond to it, increasing with higher speed to minimize damage to both persons.

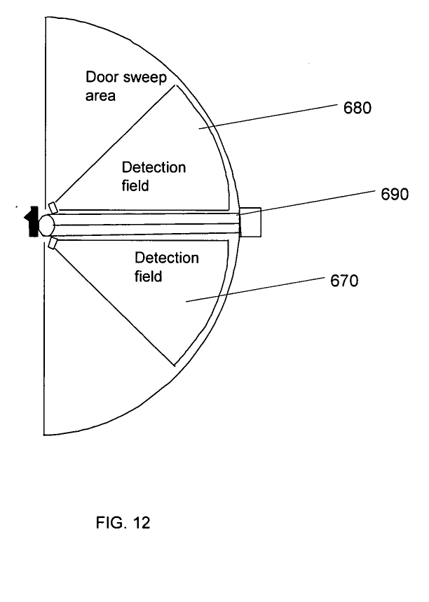

As in the scenario shown in FIGS. 9-10, this scenario preferably utilizes two PIR sensors on either side of the door, and a voltage sensor on the brake motor terminals. The PIR detection fields are illustrated in FIG. 12. In this scenario, both sides have symmetric priority from the standpoint of the system. The detection fields 670, 680 are wider and extend out further to protect from moving objects simultaneously coming toward the door 690. A wider detection field helps to obviate the need for more exotic detection of the Pusher velocity.

The third scenario is the use of the system to prevent or mitigate the effect of a door being closed on an object such as a finger or foot.

In this scenario, a door is open and either a pusher or a puller is moving to close the door. An object such as a hand or a foot is moved between the door edge and the jamb. The door is closed on the hand or foot resulting in a painful injury.

In this mode, the source of the closing force is not relevant. The important fact is whether an object is in line to be pinched between the door and the jamb when the door is closed.

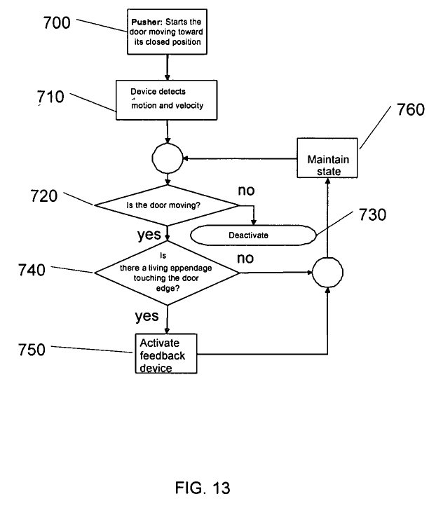

The flowchart for this case, shown in FIG. 13, is similar to the one shown in FIG. 11, with the exception that the presence of a hand or other appendage is monitored rather than door proximity. There are various methods that can be used in this scenario. In one embodiment, if the pusher/puller starts the door closing from the fully open position, and a hand is detected on the door edge, the system need not be engaged. However, when the door is close to the jamb, the system is engaged if a hand or finger is detected on the door. This requires that the door location be monitored with some accuracy.

In another embodiment, shown in FIG. 13, the system activates whenever the door is being closed and an object is determined to be between the door and the door jamb. This embodiment does not require exact knowledge of door location, it simply requires relative locations of the door, the obstruction and the door jamb. Alternatively, the system may utilize a touch sensor to determine whether the doorjamb is being touched in order to activate the force feedback device.

FIG. 13 shows a flowchart of this embodiment. The pusher starts closing the door in step 700. The system detects the movement of the door and its direction, in box 710. The system determines whether there is something touching the door edge in box 740. If so, the system is activates in box 750. Otherwise, the system maintains its state, as shown in box 760.

In one embodiment, this usage mode requires that human (or animal) touch be detected as well as door motion and position. The position can be interpolated to a reasonable degree of accuracy by sensing the terminal voltage on the brake motors while running in passive mode. The touch sensor is a metal bar that is taped or glued to the outermost door edge on the jamb side, and connected to a CT sensor. Alternatively, it can be placed on the door frame itself.

In another embodiment, an IR sensor is used to detect the presence of an object between the door and the door jamb.

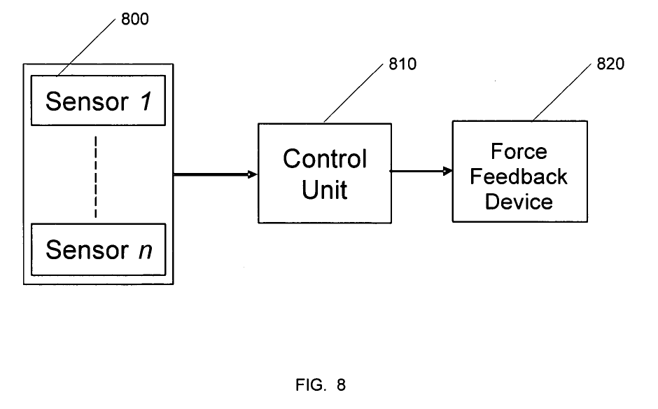

Finally, as shown in FIG. 8, in addition to the force feedback device 820 and the sensors 800, the system preferably has a control unit 810. The control unit 810 interprets data from the various sensors 800 and controls the action of the system. The heart of the unit is a microcontroller such as those made by Microchip™ (PIC 16 series), or Atmel™ (AVR). Some analog to digital conversion capability is desired to more accurately measure analog values of the CT and Voltage sensors.

While this above disclosure described tactile feedback systems, typically for household use, the invention is not so limited. As described earlier, instead of (or in addition to) the tactile feedback, audio or visual feedback can be provided through the use of lights or speakers. This can be as simple as a warning tone or synthesized voice that warns the actors on either side of the door that there is potential danger. It may also be accompanied by some form of visual indicator, such as an LED. For example, the sensors used above to generate the input for the force feedback device can be used to provide an input to a audio or visual warning system. In one embodiment, the Passive or Active IR sensors or ultrasonic sensor can provide an input to a controller. In another embodiment, a mass related sensor, such as a mat to detect weight as are common for automatic doors, can be used. Using the logic explained above, the controller can determine whether an obstruction is on the opposite side of the door. Having made this determination, a visual alert, such as an LED, or an audio alert, such as a beeper, can be activated.

Alternatively, the tactile feedback may be in a different form. In this embodiment, the feedback is preferably provided by a vibrating device affixed to the door. This vibrating device could be a scaled up version of the vibrators installed in cell phones and pagers. When a user opens a door with something directly behind it, the vibrator is activated, and the alert is transferred through the door itself.

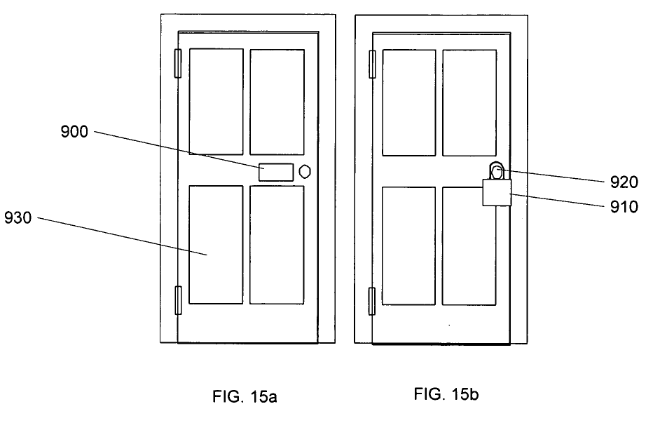

FIG. 15 illustrates two representative methods of attaching such a device. In FIG. 15a, the device 900 is shown affixed to the door 930 itself, so that vibration is transferred to the user by contact through the door. In FIG. 15b, the device 910 is tightly coupled to the door knob 920 itself. When an obstruction is detected, the device vibrates the door knob 920 itself.

Any of these alternate systems could utilize most of the flowcharts described earlier. However, rather than controlling the door's movement, these systems would alert the user in an alternate way.

Furthermore, the present invention is useful in other applications. For example, the mechanisms described above can be used for a vehicle door, to alert the operator of the potential of hitting another object. One such use may be in a parking lot, where an adjacent car may be perceived as an obstruction. A similar situation may exist in a garage or other structure where the walls are relatively close to the vehicle.

What is claimed is:

1. A system for minimizing potential impacts, when a user opens a door, comprising:
a. A sensor for detecting the presence of an obstruction on the side of the door opposite said user,
b. A feedback device for providing feedback to said user, when an obstruction is detected, and
c. A control unit for receiving input from said sensor and providing input to said feedback device.

2. The system of claim 1, wherein said feedback comprises visual means.

3. The system of claim 1, wherein said feedback comprises audio means.

4. The system of claim 1, wherein said feedback comprises tactile means.

5. The system of claim 4, wherein said feedback comprises a vibration of said door.

6. The system of claim 4, wherein said feedback comprises a change in the force required to open said door.

7. The system of claim 6, wherein said feedback device comprises a motor.

8. The system of claim 6, wherein said feedback device comprises two motors.

9. The system of claim 8, wherein said motors are configured so as to oppose each other when said obstruction is detected, so as to increase the force needed to open said door.

10. The system of claim 7, wherein said motor is configured to provide power to said system when said obstruction is not detected.

11. The system of claim 6, wherein said feedback device comprises a cylinder having a viscous fluid and a paddle located within said cylinder.

12. The system of claim 11, wherein said paddle rotates when said obstruction is detected.

13. The system of claim 11, wherein said paddle does not rotate when said obstruction is not detected.

14. A method for minimizing the potential impact, when a user opens a door, comprising:
a. Providing a system comprising a sensor, a feedback device for providing feedback to said user, and a control unit for receiving input from said sensor and providing input to said feedback device;
b. Detecting the presence of an obstruction on the side of the door opposite said user using said sensor,
c. Using said control unit to activate said feedback device; and
d. Using said feedback device to alert said user of said presence.

15. The method of claim 14, whereby said feedback comprises visual means.

16. The method of claim 14, whereby said feedback comprises audio means.

17. The method of claim 14, whereby said feedback comprises tactile means.

18. The method of claim 17, whereby said feedback comprises a vibration of said door.

19. The method of claim 17, whereby said feedback comprises a change in the force required to open said door.

20. The method of claim 19, whereby said feedback device comprises a motor.

21. The method of claim 19, whereby said feedback device comprises two motors.

22. The method of claim 21, further comprising configuring said motors so that they oppose each other when said obstruction is detected, so as to increase the force needed to open said door.

23. The method of claim 20, further comprising configuring said motor to provide power to said system when said obstruction is not detected.

24. The method of claim 19, whereby said feedback device comprises a cylinder having a viscous fluid and a paddle located within said cylinder.

25. The method of claim 24, further comprising rotating said paddle when said obstruction is detected.

26. The method of claim 24, further comprising not rotating said paddle when said obstruction is not detected.
